(19) United States
(12) Patent Application Publication
(10) Pub. No.: US 2012/0096030 A1
(43) Pub. Date: Apr. 19, 2012

(54) METHOD AND APPARATUS FOR PROVIDING SEARCH RESULTS BY USING PREVIOUS QUERY

(75) Inventor: Taeil Kim, Seongnam-si (KR)

(73) Assignee: NHN CORPORATION, Seongnam-si (KR)

(21) Appl. No.: 13/378,665

(22) PCT Filed: Jun. 10, 2010
(86) PCT No.: PCT/KR2010/003743

§ 371 Date: Dec. 15, 2011

(30) Foreign Application Priority Data
Jun. 19, 2009 (KR) 10-2009-0054804

(51) Int. Cl. G06F 17/30

(52) U.S. Cl. 707/775; 707/E17.014

(57) ABSTRACT

A method for providing the search results by using a previous query according to one embodiment of the present invention, which is able to provide the search results that coincide with the user's intention, comprises the steps of: selecting as a second query one query among queries that are inputted before the input of a first query if the first query is inputted by the user; generating a third query by using the first and second queries; and performing a searching process by using the third query to provide the generated search results to the user.

### CROSS-REFERENCE TO RELATED APPLICATIONS

This application is the National Stage Entry of International Application PCT/KR2010/003743, filed on Jun. 10, 2010, and claims priority from and the benefit of Korean Patent Application No. 10-2009-0054804, filed on Jun. 19, 2009, all of which are incorporated by reference for all purposes as if fully set forth herein.

### BACKGROUND OF THE INVENTION

1. Field of the Invention

The present invention relates to information provision, and more particularly, to search results provision through the Internet.

2. Discussion of the Background

In accordance with the development and increasing diffusion of the Internet, various services have been provided via the Internet. A typical example of the various services is a search service which refers to a service for performing a search for a predetermined query input by a user, and providing, to the user, search results corresponding to the input query.

In particular, in order to provide the search service, a search service providing system collects information about websites in advance, and indexes and stores the collected information to build a database. If a user inputs, as a query, a word or a combination of words desired to be searched for, the search service providing system provides, to the user, search result documents corresponding to the input query, for example, a website, an article, an image of which a file name includes the query input by the user, and the like.

However, in the aforementioned general search service, if the query input by the user corresponds to a word having an ambiguous meaning, the search service providing system may constantly provide only the same search results if the same query is input, since it is difficult to identify the intention of the user inputting the corresponding query.

For example, if the user inputs a query ‘AAA,’ the search service providing system may fail to determine whether the input query corresponds to a query input in order to obtain search results for a comedian ‘AAA,’ or a query input in order to obtain search results for a conductor ‘AAA.’ Accordingly, the search service providing system may constantly provide only the same search results regardless of the intention of the user.

In this example, if search result documents including information about the conductor ‘AAA’ are displayed at the top of the search results for a user searching for the comedian ‘AAA,’ or if search result documents including information about the comedian ‘AAA’ are displayed at the top of the search results for a user searching for the conductor ‘AAA,’ user satisfaction of the search may decrease, and this may harm user's reliability for a search service provider.

### SUMMARY OF THE INVENTION

In order to resolve the foregoing problem, an aspect of the present invention provides a method and apparatus for providing search results using a previous query, which may provide search results that match an intention of a user.

Another aspect of the present invention provides a method and apparatus for providing search results using a previous query, which may provide search results that may match an intention of a user, using a previous query among queries input by the user.

Still another aspect of the present invention provides a method and apparatus for providing search results using a previous query, which may provide search results that match an intention of a user, although the user is not logged in.

According to an aspect of the present invention, there is provided a method of providing search results using a previous query, the method including selecting a second query from previous queries that are input before an input of a first query, if the first query is input by a user; generating a third query using the first query and the second query; and providing, to the user, search results generated by performing a search using the third query.

In this instance, a previous query that is input just before the input of the first query may be selected, as the second query, from the previous queries input before the input of the first query, or a previous query that is most recently input and different from the first query may be selected, as the second query, from the previous queries input before the input of the first query. Here, a plurality of queries may be selected from the previous queries as the second query.

The third query may be generated by combining the first query and the second query using Boolean operators. For example, the third query may be generated by combining the first query and the second query using an AND operator, and combining the first query and the second query combined using the AND operator, with the first query using an OR operator.

The previous queries input before the input of the first query may be obtained from a cookie stored in a terminal of the user, a query database to store all queries input by the user, or session information of the user.

The method may further include, before the generating of the third query, determining whether the first query input by the user is included in a related query list of the second query. The third query may be generated using the first query and the second query if the first query is included in the related query list of the second query.

The method may further include storing the first query in a cookie of a user terminal, a query database, or session information of the user. In this instance, the first query may be stored in the query database if the user is logged in, and may be stored in the cookie of the user terminal or the session information of the user if the user is not logged in.

According to another aspect of the present invention, there is provided an apparatus for providing search results using a previous query, the apparatus including a user interface unit to receive an input of a first query from a user, and to provide, to the user, search results for the first query, a query selecting unit to select, as a second query, a previous query from previous queries that are input before the input of the first query if the first query is input through the user interface unit, a query generating unit to generate a third query using the first query and the second query, and a searching unit to generate the search results by performing a search using the third query.

According to exemplary embodiments of the present invention, an effect of improving satisfaction of a search may be achieved by providing search results that match an intention of a user for a predetermined query.

According to exemplary embodiments of the present invention, an effect of improving satisfaction of a search and reliability of a search service may be obtained, by displaying, on the top of search results, search result documents including a query desired to be actually searched for by a user if the query input by the user corresponds to a word having an ambiguous meaning, or by displaying, on the top of search results, search result documents that match an intention of the user even if the query input by the user corresponds to a word without an ambiguous meaning, since a search may be performed using a previous query if the search for the query input by the user is performed.

According to exemplary embodiments of the present invention, an effect of extending a scope of a search service may be obtained, by providing search results that match an intention of a user although the user is not logged in.

### BRIEF DESCRIPTION OF THE DRAWINGS

FIG. 1 is a block diagram illustrating an apparatus for providing search results according to an exemplary embodiment of the present invention.

FIG. 2 is a diagram illustrating a screen providing search results according to an exemplary embodiment of the present invention.

FIG. 3 is a diagram illustrating a screen providing search results according to another exemplary embodiment of the present invention.

FIG. 4 is a diagram illustrating a screen providing general search results.

FIG. 5 is a diagram illustrating a screen showing an input of a query using a related query list.

FIG. 6 is a flowchart illustrating a method of providing search results according to an exemplary embodiment of the present invention.

FIG. 7 is a flowchart illustrating a method of providing search results according to another exemplary embodiment of the present invention.

### DETAILED DESCRIPTION OF THE ILLUSTRATED EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

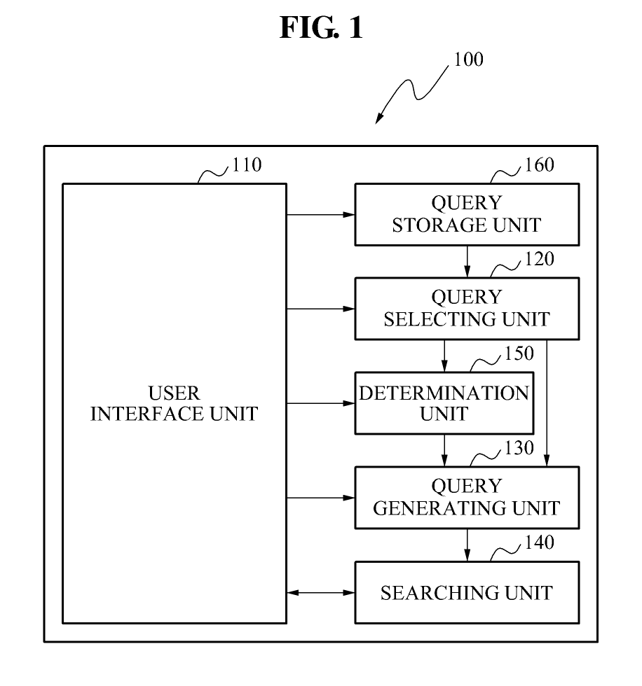

FIG. 1 is a block diagram illustrating an apparatus for providing search results using a previous query, which will be referred to hereinafter as a ‘search result providing apparatus,’ according to an exemplary embodiment of the present invention. As illustrated in FIG. 1, the search result providing apparatus 100 may include a user interface unit 110, a query selecting unit 120, a query generating unit 130, and a searching unit 140.

The user interface unit 110 may receive, from a user, an input of a first query corresponding to a query desired to be searched for by the user, and may provide, to the user, search results generated by the searching unit 140 which will be described later.

The query selecting unit 120 may select, as a second query, a previous query from previous queries that are input before the first query is input by the user if the first query is input through the user interface unit 110.

The query selecting unit 120 may select a previous query that is input just before the first query is input, as the second query, from the previous queries input before the first query is input by the user.

For example, if it is assumed that the user may have input a query “ABC” and a query “AAB” before, and may input “AAA” as a first query, the query selecting unit 120 may select the query “AAB” input just before the query “AAA” is input, as a second query, from the query “ABC” and the query “AAB” input before the first query “AAA” is input.

If the selected second query is identical to the first query, the query selecting unit 120 may select a previous query that is most recently input and different from the first query, as the second query, from the previous queries input before the input of the first query.

For example, if it is assumed that the user has input a query “ABC,” a query

“AAB,” and a query “AAA”, and may input the query “AAA” as a first query, the query selecting unit 120 may select the query “AAA” input just before the first query “AAA” is input, as a second query, from the query “ABC,” the query “AAB,” and the query “AAA” input before the first query “AAA” is input. However, since the second query is identical to the first query, the query selecting unit 120 may select the query “AAB” that is different from the first query and that is most recently input as the second query.

The query selecting unit 120 may obtain the previous queries used to select the second query, from a cookie stored in a terminal of the user, a query database (not shown) to store all queries input by the user, or session information of the user.

In this instance, if a user is logged in, the previous queries input by the corresponding user may be obtained from the query database, based on identification (ID) of the user. If the user is not logged in, the previous queries input by the user may be obtained from the cookie of the corresponding user terminal or the session information of the user.

The query generating unit 130 may generate a third query using the first query and the second query. The query generating unit 130 may generate the third query by combining the first query and the second query using Boolean operators.

In particular, the query generating unit 130 may generate the third query by combining the first query and the second query using an AND operator, and combining the first query and the second query combined using the AND operator, with the first query using an OR operator.

For example, if the first query corresponds to “AAA,” and the second query corresponds to “DDD,” the query generating unit 130 may generate the third query in a form of

“(DDD & AAA)|AAA”. Here, “&” denotes the AND operator, and “|” denotes the OR operator.

Here, the first query and the second query may be combined using the AND operator since an intention of the user inputting the first query may be related to the second query, and the first query and the second query combined using the AND operator may be combined with the first query using the OR operator in order to prevent a problem in that the number of search results, provided when a search is performed by combining only the first query and the second query using the AND operator, may be less than the number of search result documents provided when the search is performed using only the first query.

If the third query is generated by combining the first query and the second query using the AND operator and combining the first query and the second query combined using the AND operator with the first query using the OR operator, all documents including the first query may be searched for, and priorities of documents including both the first query and the second query may also be increased.

Although it has been described that the query generating unit 130 may generate the third query using Boolean operators, this is exemplary and it may be possible to apply any other method that may provide search results for the first query and may additionally display, at the top of the search results, search result documents including the second query.

The searching unit 140 may generate the search results by performing a search using the third query generated by the query generating unit 130 and may provide the generated search results to the user through the user interface unit 110.

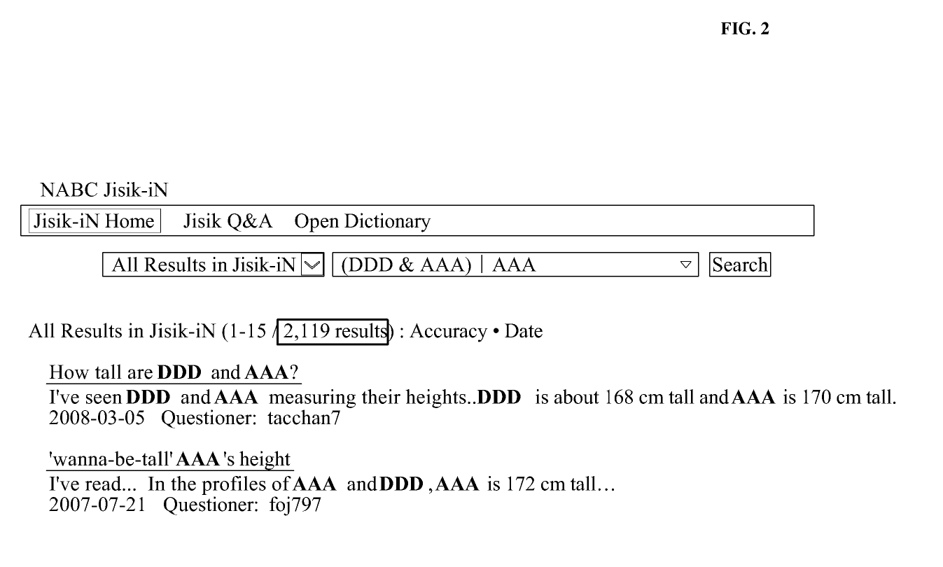

FIG. 2 illustrates an example of search results generated by the searching unit 140 when a third query generated by the query generating unit 130 corresponds to “(DDD & AAA)|AAA.” As illustrated in FIG. 2, search result documents including both a first query “AAA” and a second query “DDD” may be displayed at the top of search results including all search result documents including the first query “AAA.”

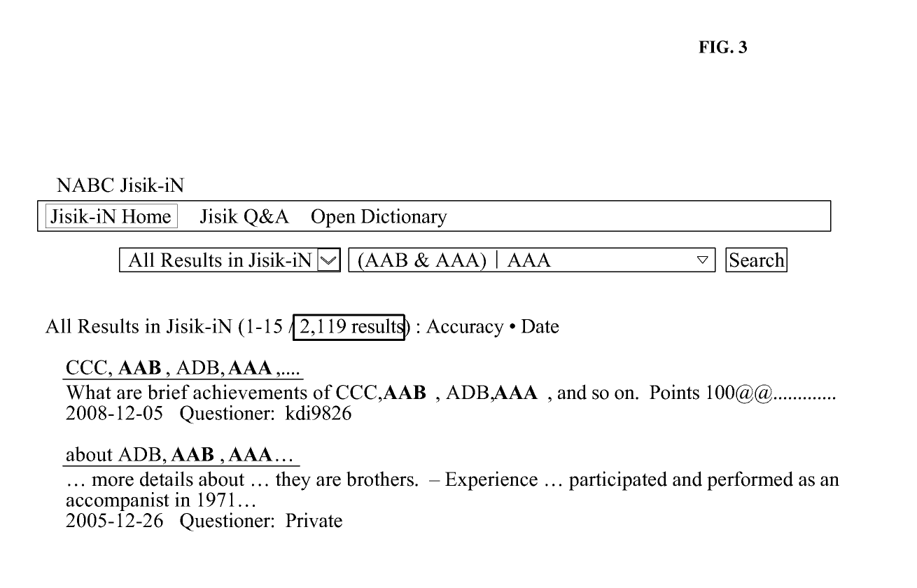

FIG. 3 illustrates an example of search results generated by the searching unit 140 when a first query corresponds to “AAA” and a second query corresponds to “AAB.” As illustrated in FIG. 3, search result documents including both the first query “AAA” and the second query “AAB” may be displayed at the top of search results including all search result documents including the first query “AAA.”

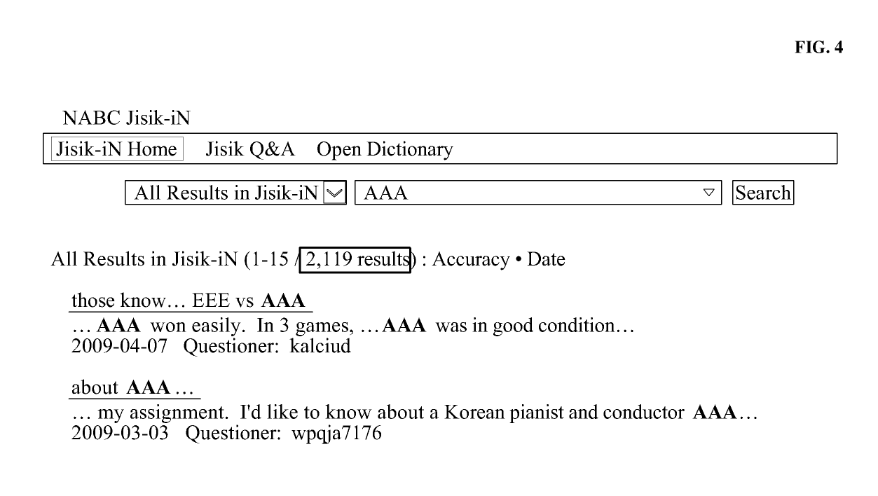

When respectively comparing FIG. 2 and FIG. 3 which illustrate the search results generated by the searching unit 140 with FIG. 4 which illustrates search results generated by performing a search using only the first query “AAA” input by the user, the same number of search result documents, that is, 2119, may be included in the search results in every case. That is, the results of performing the search using only the first query, and the results of performing the search using the third query generated using the first query and the second query may be identical. Accordingly, search results may remain the same, and priorities of search result documents that match an intention of the user may be increased.

As described in the foregoing examples of FIG. 2, FIG. 3, and FIG. 4, since the first query “AAA” is identically applied, the number of search result documents may be identical in every case. However, the priorities of the search result documents included in the search results may differ depending on the second queries, as illustrated in FIG. 2 and FIG. 3.

According to exemplary embodiments of the present invention, a search may be performed using a third query generated by combining a first query and a second query. Accordingly, documents desired to be actually searched for by a user may be displayed at the top of search results when the first query corresponds to a word having an ambiguous meaning, and search result documents that match an intention of the user may be displayed at the top of search results when the first query corresponds to a word without an ambiguous meaning.

For example, if the user inputs a query “SS Entertainment” just after inputting a query “AA group,” the first query may not be a word having an ambiguous meaning since the first query may correspond to “SS Entertainment” and the second query may correspond to “AA group.” However, search result documents associated with “AA group” among all search result documents associated with “SS Entertainment” may be displayed at the top of the search results.

Although it has been described that, for every first query, a third query may be generated using a first query and a second query, and search results generated by performing a search using the third query may be provided to the user. However, in another exemplary embodiment, the third query may be generated using the first query and the second query only when the first query satisfies a predetermined requirement by determining whether the first query satisfies the predetermined requirement. In order to achieve the foregoing, the search result providing apparatus 100 may further include a determination unit 150.

The determination unit 150 may determine whether the first query is included in a related query list of the second query, and may provide a result of the determination to the query generating unit 130. The query generating unit 130 may generate the third query using the first query and the second query when the first query is included in the related query list of the second query.

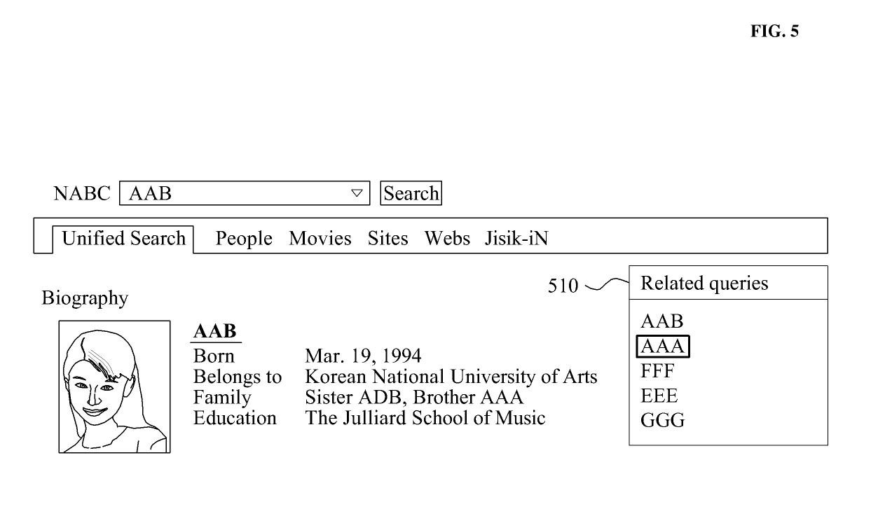

For example, as illustrated in FIG. 5, when it is assumed that the user has input a query “AAB” before, and may select a query “AAA” from a related query list 510 included in search results for the query “AAB,” the query “AAA” may correspond to a first query, and the query “AAB”, input just before the input of the query “AAA”, may correspond to a second query. In this instance, the determination unit 150 may determine whether the first query “AAA” is selected in the related query list 510 of the second query “AAB”, and may transfer a result of the determination to the query generating unit 130. In this example, the determination unit 150 may transfer, to the query generating unit 130, a result indicating that the first query “AAA” is selected in the related query list 510 of the second query “AAB.”

The search result providing apparatus 100 may further include a query storage unit 160 to store the first query in a cookie stored in a user terminal, a query database, or session information of the corresponding user so that the first query input by the user may be used as a previous query.

In this instance, the query storage unit 160 may store the first query in the query database by associating the first query with an ID of the user if the user is logged in, and may store the first query in the cookie of the corresponding user terminal or the session information of the corresponding user if the user is not logged in.

The query selecting unit 120 may select, as the second query, a query from the previous queries. However, in another embodiment, the query selecting unit 120 may select, as the second query, one or more queries from the previous queries.

In this instance, the query generating unit 130 may generate the third query using the first query and at least one second query. The query generating unit 130 may generate the third query by combining the first query and the at least one second query using Boolean operators.

For example, if it is assumed that the user may sequentially input a query “ABC,” a query “AAB,” and a query “AAA,” the first query may correspond to “AAA,” and both “ABC” and “AAB” may be selected, as the second query (“second queries”). In this example, the query generating unit 130 may generate the third query in a form of “(ABC & AAB & AAA)|(AAB & AAA)|AAA.”

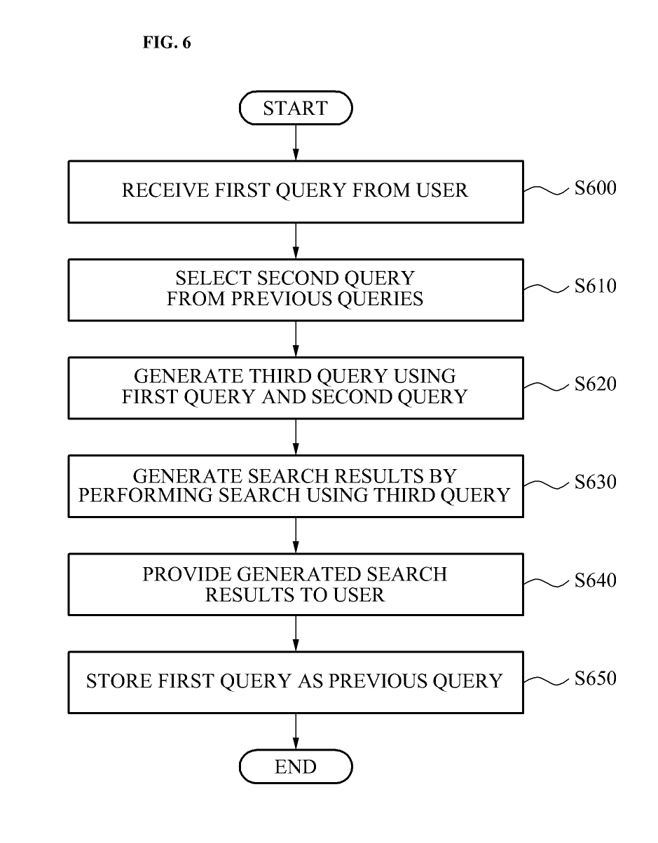

A method of providing search results using a previous query according to exemplary embodiments of the present invention will be described hereinafter with reference to FIG. 6. FIG. 6 is a flowchart illustrating a method of providing search results according to an exemplary embodiment of the present invention.

As illustrated in FIG. 6, if a first query is received from a user in operation S600, a previous query may be selected, as a second query, from previous queries input by the user before the input of the first query, in operation S610. In this instance, a query that is input just before the first query is input by the user may be selected, as the second query, from the previous queries input before the first query is input by the user. If the selected second query is identical to the first query, a previous query that is most recently input and different from the first query may be selected, as the second query, from the previous queries input before the input of the first query.

The previous queries used to select the second query may be obtained from a cookie stored in a user terminal, a query database to store all queries input by the user, or session information of the user.

In operation S620, the third query may be generated using the first query input by the user, and the selected second query. In this instance, the third query may be generated by combining the first query and the second query using Boolean operators. In particular, the third query may be generated by combining the first query and the second query using an AND operator and combining the first query and the second query combined using the AND operator with the first query using an OR operator.

If the third query is generated by combining the first query and the second query using the AND operator and combining the first query and the second query combined using the AND operator with the first query using the OR operator, all documents including the first query may be searched for, and priorities of documents including both the first query and the second query may be increased.

Although it has been described that the third query may be generated using Boolean operators, this is exemplary and it may be possible to apply any other method that may provide search results for the first query and may additionally display, at the top of the search results, search result documents including the second query.

In operation S630, search results may be generated by performing a search using the generated third query. In operation S640, the generated search results may be provided to the user. Since the search is performed using the third query generated using the first query and the second query, documents desired to be searched for by the user may be displayed at the top of the search results if the first query corresponds to a word having an ambiguous meaning. In addition, search result documents that match an intention of the user may be displayed at the top of search results even if the first query corresponds to a word without an ambiguous meaning.

In operation S650, the first query may be stored in a query database, a cookie of the corresponding user terminal, or session information of the corresponding user so that the first query may be used as a previous query.

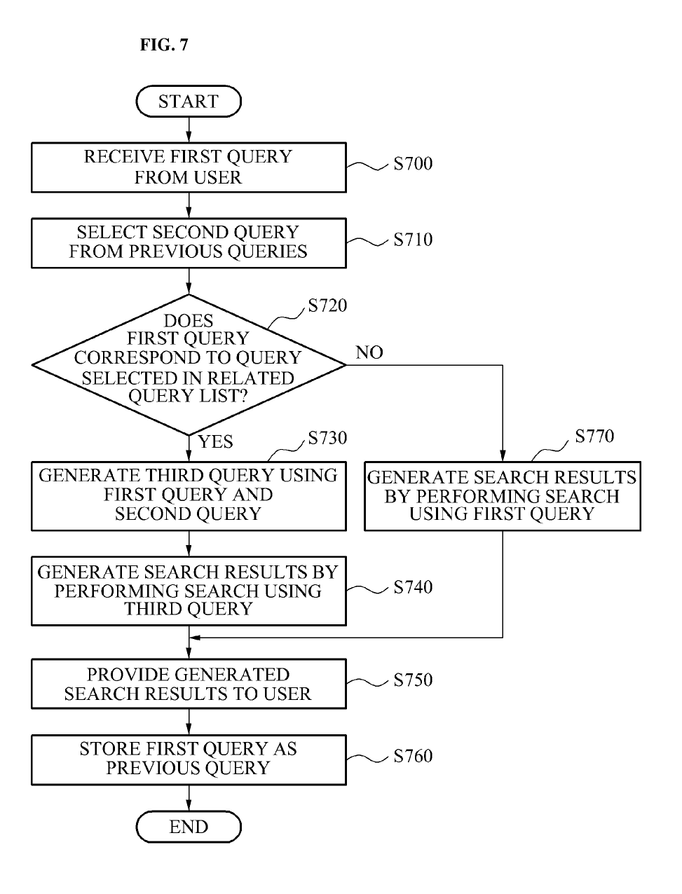

FIG. 7 is a flowchart illustrating a method of providing search results according to another exemplary embodiment of the present invention.

If a first query is received from a user in operation S700, a previous query may be selected, as a second query, from previous queries input by the user before the input of the first query, in operation S710. A process of selecting the second query may be identical to the process as illustrated in FIG. 6 and thus, a detailed description will be omitted for conciseness.

In operation S720, whether the first query corresponds to a query selected in a related query list of the second query may be determined. As a result of the determination, if the first query corresponds to a query selected in the related query list of the second query, the operations S620 through S650 which have been described with reference to FIG. 6 may be performed in operations S730 through S760.

However, as the result of the determination in operation S720, if the first query does not correspond to a query selected in the related query list of the second query, search results may be generated by performing a search using the first query in operation S770. In operation S750, the generated search results may be provided to the user. In operation S760, the first query may be stored in a query database so that the first query may be used as a previous query.

The above-described method of providing search results using a previous query may be recorded, stored, or fixed in one or more computer-readable media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts.

Examples of computer-readable media include magnetic media such as hard disks, floppy disks, and magnetic tape; optical media such as CD-ROM disks and DVDs;

magneto-optical media such as optical disks; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments.

Instead, it would be appreciated by those skilled in the art that changes may be made to these embodiments without departing from the principles and spirit of the invention, the scope of which is defined by the claims and their equivalents.

1. A method that uses a processor to provide search results using a previous query, the method comprising:
selecting a second query from previous queries that are input before an input of a first query in response to the first query is input by a user;
generating, using the processor, a third query using the first query and the second query; and
providing search results generated by performing a search using the third query.

2. The method of claim 1, wherein a previous query that is input just before the input of the first query is selected, as the second query, from the previous queries input before the input of the first query.

3. The method of claim 1, wherein the third query is generated by combining the first query and the second query using a Boolean operator.

4. The method of claim 1, wherein the third query is generated by generating a fourth query by combining the first query and the second query using an AND operator and by combining the fourth query with the first query using an OR operator.

5. The method of claim 1, wherein the previous queries are obtained from a cookie stored in a terminal of the user, a query database to store queries input by the user, or session information of the user.

6. The method of claim 1, further comprising:
determining whether the first query input by the user is included in a related query list of the second query,
wherein the third query is generated using the first query and the second query in response to the first query is included in the related query list of the second query.

7. The method of claim 1, wherein a previous query that is most recently input and different from the first query is selected, as the second query, from the previous queries input before the input of the first query.

8. The method of claim 1, wherein the selecting of the second query comprises selecting a plurality of queries, as the second query, from the previous queries.

9. The method of claim 1, further comprising:
storing the first query in a cookie of a user terminal, a query database, or session information of the user.

10. The method of claim 9, wherein
the first query is stored in the query database in response to the user is logged in, and
the first query is stored in the cookie of the user terminal or the session information of the user in response to the user is not logged in.

11. A non-transitory computer-readable medium comprising a program for instructing a computer to perform the method of claim 1.

12. An apparatus to provide search results using a previous query, the apparatus comprising:
a user interface unit to receive an input of a first query from a user, and to provide search results to the user in response to the first query;
a query selecting unit to select a previous query as a second query from previous queries that are input before the input of the first query in response to receipt of the first query;
a query generating unit to generate a third query using the first query and the second query; and
a searching unit to generate the search results by performing a search using the third query.

13. The apparatus of claim 12, wherein the query selecting unit selects a previous query that is input just before the input of the first query as the second query from the previous queries input before the input of the first query.

14. The apparatus of claim 12, wherein the query selecting unit selects a previous query that is most recently input and different from the first query, as the second query, from the previous queries input before the input of the first query.

15. The apparatus of claim 12, wherein the query selecting unit selects a plurality of queries as the second query, from the previous queries input before the input of the first query.

16. The apparatus of claim 12, wherein the query generating unit generates the third query by combining the first query and the second query using a Boolean operator.

17. The apparatus of claim 12, wherein the query generating unit generates the third query by generating a fourth query by combining the first query and the second query using an AND operator and by combining the fourth query with the first query using an OR operator.

18. The apparatus of claim 12, wherein the query selecting unit obtains the previous queries from a cookie stored in a terminal of the user, a query database to store queries input by the user, or session information of the user.

19. The apparatus of claim 12, further comprising:
a determination unit to determine whether the first query is included in a related query list of the second query,
wherein the query generating unit generates the third query using the first query and the second query in response to a determination that the first query is included in the related query list of the second query.

20. The apparatus of claim 12, further comprising:
a query storage unit to store the first query in a cookie of a user terminal, a query database, or session information of the user.

21. The apparatus of claim 20, wherein
the query storage unit stores the first query in the query database in response to a determination that the user is logged in, and
the query storage unit stores the first query in the cookie of the user terminal or the session information of the user in response to a determination that the user is not logged in.

22. A method for providing a search result using a previous query, the method comprising:
receiving a first query from a user;
providing a search result comprising a first search result group generated by performing a search using a third query and a second search result group generated by performing a search using the first query,
wherein the third query is generated using the first query and a second query, and the second query comprises one or more previous queries.

23. The method of claim 22, wherein the second query is selected among multiple previous queries received before receipt of the first query, based on a received order of each of the multiple previous queries.

24. The method of claim 23, wherein the second query is selected among multiple previous queries that are different from the first query.

25. The method of claim 22, wherein the second query is selected among multiple previous queries received from the user, and the third query is generated in response to a determination that the first query is included in a related query list of the second query.

26. The method of claim 22, wherein
the second query comprises a first previous query and a second previous query,
the first search result group comprises a first search result subgroup and a second search result subgroup, and
the first search result subgroup is generated based on at least the first previous query and the second search result subgroup is generated based on at least the second previous query.

27. The method of claim 22, wherein the first search result group has higher priority than the second search result group.
